(19) United States
(12) Patent Application Publication
(10) Pub. No.: US 2014/0096492 A1
(43) Pub. Date: Apr. 10, 2014

(54) DEVICE AND METHOD FOR OPENING A COVER

(71) Applicant: BOEWE SYSTEC GmbH, Augsburg (DE)

(72) Inventors: Ronald CELESTE, Kuehlenthal (DE); Robert BAYER, Diedorf (DE)

(21) Appl. No.: 14/101,952

(22) Filed: Dec. 10, 2013

Related U.S. Application Data
(63) Continuation of application No. PCT/EP2012/063259, filed on Jul. 6, 2012.

(30) Foreign Application Priority Data
Jul. 11, 2011 (DE) 102011078975.8

(51) Int. Cl. B43M 3/04

(52) U.S. Cl. CPC B43M 3/045
USPC 53/492; 53/569; 53/284.3

(57) ABSTRACT

A device for opening a cover while using a fluid includes an opener for at least partly separating a cover front side and a cover rear side of the cover, the opener being configured to provide, for the fluid introduced into the cover, a deflection position between a cover opening and a cover bottom.

### CROSS-REFERENCE TO RELATED APPLICATIONS

This application is a continuation of copending International Application No. PCT/EP2012/063259, filed Jul. 6, 2012, which is incorporated herein by reference in its entirety, and additionally claims priority from German Application No. 102011078975.8, filed Jul. 11, 2011, which is also incorporated herein by reference in its entirety.

Embodiments of the present invention relate to the field of inserting goods into covers, for example to inserting one or more goods into an envelope, and here in particular to an approach of initially opening the cover, to an envelope inserter as well as to a paper-handling plant.

### BACKGROUND OF THE INVENTION

Envelope inserters which enable an envelope or a cover to be filled with one or more goods receive, at a filling position or at the beginning of a filling path, both a cover or an envelope and the goods item to be inserted. To enable trouble-free insertion of the item into the envelope, it is useful to open the envelope before the item to be inserted reaches the envelope opening, so that the item to be inserted may be introduced into the envelope without any hindrance. Some envelope inserters include mechanical elements, for example in the form of suction cups, which contact the two opposite sides of the envelope at the filling position and move them relative to each other so as to separate (to open) the front and rear sides of the envelope. However, such approaches involve a large amount of mechanical overhead and can be realized only in connection with envelope inserters functioning in start-stop operation. With continuously operating envelope inserters, wherein the item and the envelope are moved during the insertion process, such an opening mechanism is not possible. Alternatively, the envelope may be opened by a quick blast of a fluid, for example of blow air, in the direction of the envelope. Depending on the circumstances, the separation achieved in this manner may be sufficient for inserting the goods into the envelope; however, provision may also be made for providing additional elements for supporting the filling process, in particular for supporting the process of opening the envelope and keeping it open, and of performing at least partial insertion into the envelope opening once the envelope has been subjected to blow air. Here, filling aids are used, for example, which may be readily introduced into the at least partly opened envelope due to utilization of blow air, and which keep said envelope open until the item is inserted. For example, filling pockets may also be introduced into the envelope thus opened, which filling pockets carry along the item to be inserted, so that the latter does not collide with the edges of the opened envelope.

In the field of envelope inserters it is desired to maximize throughput, i.e. the number of goods inserted into envelopes per time unit. However, one has found, within the context of studies performed by the applicant, that the opening process using a fluid, for example blow air, is unnecessarily time-consuming, so that in particular in high-performance envelope insertion systems, there are undesired delays and, thus, undesired performance losses.

The phenomenon which occurs during opening of an envelope and gives rise to delays will be explained in more detail with reference to FIG. 1. FIG. 1(a) shows an envelope 100 including an envelope front side 102, an envelope rear side 104, an envelope bottom 106 at which the envelope front side 102 and the envelope rear side 104 are connected, for example bonded, to each other, and an envelope opening 108. The envelope 100 further comprises a flap 110 connected to the envelope front side 102, the connecting line between the envelope flap 110 and the envelope front side 102 being referred to as the hinge line HL. FIG. 1(a) shows a schematic representation of an envelope in a state in which it is being fed to an envelope insertion device, i.e. before the envelope has been acted upon by blow air, to open same. FIG. 1(a) provides an exaggerated view of the envelope, in particular of its envelope opening 108, so as to be able to illustrate the phenomenon underlying the above-mentioned problem. As is shown in FIG. 1(a), a blow air nozzle 112 is provided which outputs blow air 114 in the direction of the envelope 100, the blow air initially penetrating into the envelope 100 through the opening 108 thereof, as is illustrated by arrow 116. The blow air introduced into the envelope 100 moves in the direction of the envelope bottom 106, as is shown in FIG. 1(a).

So far it has been assumed that solely introducing the blow air into the envelope 100 in the manner shown in FIG. 1(a) causes same to open, i.e. causes an increase in the distance between the front side 102 and the rear side 104 of the envelope.

However, the applicant's studies mentioned above have revealed that this is precisely not the case (as can be seen in FIG. 1(a), the envelope does not open solely as a result of the blow air flowing in); rather, it has been found that the envelope 100 does not open until the blow air 116 flowing in has blown off the envelope bottom 106 and flows back in the direction of the envelope opening. This situation is shown in FIG. 1(b), which schematically shows the envelope shown in FIG. 1(a) in a now opened position, i.e. in a situation wherein the envelope opening 108 has been opened as compared to the original position. The higher the envelope format, i.e. the larger the dimension of the envelope between the hinge line HL and the envelope bottom 106, the longer the process will take. In addition, it has been found that the blow air 116 flowing in and the blow air 118 flowing out have different flow rates, which leads to turbulences within the envelope due to the long common distance covered by both the inflowing and the outflowing blow air, which all in all results in a slower and/or poorer envelope opening process. The blow air flowing in and the blow air flowing out have opposite flow directions, as a result of which, e.g. in relatively large envelopes, for example, no separation is achieved or separation is rendered more difficult.

### SUMMARY

According to an embodiment, a device for opening a cover while using a fluid may have: an opener for at least partly separating a cover front side and a cover rear side of the cover, the opener being configured to provide, for the fluid introduced into the cover, a deflection position between a cover opening and a cover bottom.

According to another embodiment, an envelope inserter for inserting one or more goods into a cover may have a device as claimed in claim 1.

Another embodiment may have a paper-handling plant including a device as claimed in claim 1 and/or an envelope inserter for inserting one or more goods into a cover, including a device as claimed in claim 1.

Another embodiment may have a method of opening a cover while using a fluid, a deflection position being provided, for the fluid introduced into the cover, between a cover opening and a cover bottom.

Yet other embodiments of the invention relate to a paper-handling plant including a device in accordance with embodiments of the invention and/or an envelope inserter in accordance with embodiments of the invention.

In accordance with one embodiment of the invention, the cover is an envelope comprising an envelope flap.

In accordance with embodiments of the invention, the deflection position is provided such that it is transverse to the transport direction of the cover, e.g. via means arranged accordingly and acting upon the cover in a non-contacting or contacting manner.

Further implementations of the present invention are defined in the sub-claims.

On the basis of the above-described studies, the problem underlying the delays in opening the envelopes was recognized by the applicant. In accordance with the invention, a countermeasure proposed is to provide a “virtual” envelope bottom for the opening fluid flowing into the envelope, whereby a smaller envelope height (smaller dimension between the hinge line and the virtual envelope bottom) is created for the opening process, so that the fluid flowing in is reflected at this deflection position within the cover at an earlier point in time, which results in faster and more reliable opening of the envelope.

### BRIEF DESCRIPTION OF THE DRAWINGS

Embodiments of the present invention will be detailed subsequently referring to the appended drawings, in which:

FIG. 1 shows schematic representations of an envelope for illustrating the phenomenon underlying the delay during opening of an envelope, FIG. 1(A) showing an envelope prior to being opened, and FIG. 1(B) showing an envelope after having been opened;

FIG. 2 shows a schematic representation of an envelope for illustrating the principle underlying the present invention;

FIG. 3 shows an embodiment comprising a blow air strip, FIG. 3(A) showing a schematic lateral representation of the inventive device in accordance with this embodiment, FIG. 3(B) showing a top view, and FIGS. 3(C) to (F) showing different implementations of the blow air strip;

FIG. 4 shows an embodiment with means for producing a localized fold, FIG. 4(A) showing a lateral representation of a device in accordance with this embodiment, and FIGS. 4(B) and 4(C) showing possible implementations of a support plate;

FIG. 5 shows an embodiment comprising means for creating a deflection position in a contacting manner, FIG. 5(A) showing a lateral representation of a device in accordance with this embodiment, and FIGS. 5(B) to 5(D) showing possible implementations of a stamp;

FIG. 6 shows further examples of elements for creating a deflection position in a contacting manner, FIG. 6(A) showing a spring-mounted roller, and FIG. 6(B) showing a vertically movable roller;

FIG. 7 shows a schematic representation of an envelope inserter comprising a device in accordance with embodiments of the invention; and

FIG. 8 shows a paper-handling plant comprising a device in accordance with embodiments of the invention and/or an envelope inserter in accordance with embodiments of the invention.

### DETAILED DESCRIPTION OF THE INVENTION

In the following description of the embodiments of the invention, elements which are identical or have identical actions are provided with identical reference numerals in the accompanying figures.

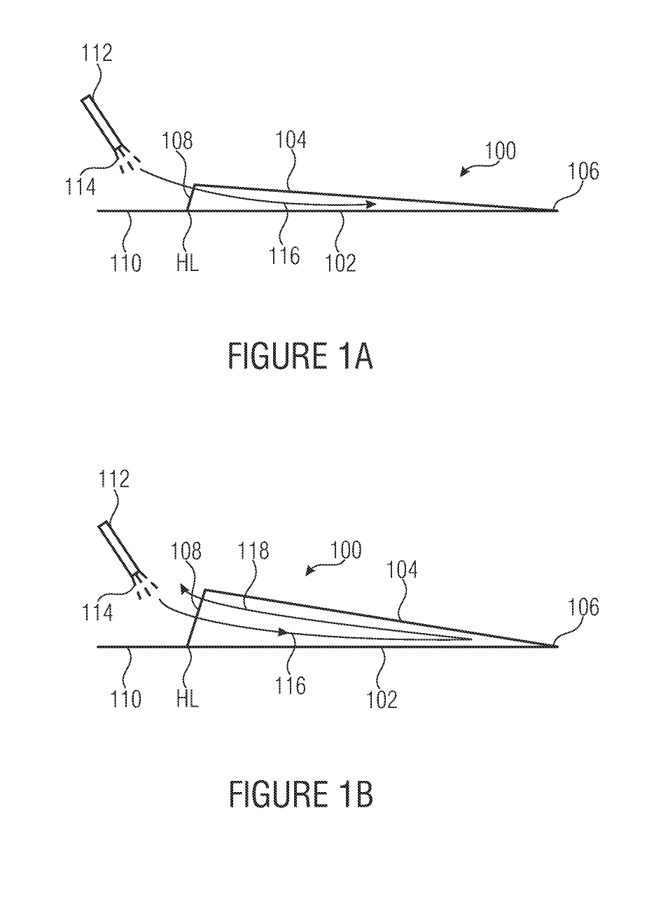

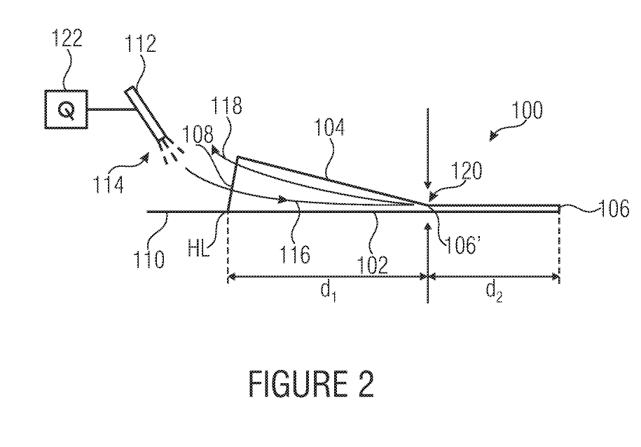

The principle underlying the present invention will be explained in more detail with reference to FIG. 2. FIG. 2 shows an envelope 100, similar to the description given in FIG. 1. The vertical arrows designate a deflection position 120 at which the envelope 100 is acted upon in a manner which will be described in more detail below, so that at this position, a virtual envelope bottom 106′ is created at which at least some of the blow air 116 flowing in is reflected, so that the blow air 118 flowing out needs to cover a shorter distance d₁, as compared to the situation described in FIG. 1, to reach the envelope opening 108 so as to leave the envelope 100. The deflection position 102 is located at a distance d₁ from the hinge line HL and at a distance d₂ from the real envelope bottom 106. Depending on the circumstances, in particular depending on the envelope size and the envelope material, the ratio between d₁ and d₂ may be adjusted so as to achieve optimum opening of the envelope 100 within a minimum amount of time. Once the envelope has been opened in the manner described in FIG. 2, an item may be introduced into the envelope 100, it being possible to introduce additional elements for keeping open the envelope that has now been opened or for supporting the filling process, for example in the form of a filling aid or a filling pocket.

Thus, FIG. 2 shows an approach wherein opening means are provided which create the virtual envelope bottom 106′ at the position 120 and which comprise a blow air nozzle 112 or a device for supplying a different, suitable fluid, for example a different gas, the fluid 114 being provided by a source 122. In the arrangement depicted in FIG. 2, the blow air 114 is directed to the envelope 100 from above at an angle; however, provision may be made, in other embodiments, for arranging the blow air nozzle 112 perpendicularly to the envelope front side 102, so that it blows perpendicularly in the direction of the envelope either from above or from below; due to the blow air 114 hitting e.g. the flap 110 and/or a support, some of the blow air flow is deflected and directed into the envelope. Moreover, provision may also be made for directing the blow air 114 in the direction of the envelope opening 108 from below at an angle. As yet another alternative, provision may be made for directing the blow air to the envelope in the direction parallel to the envelope 100, i.e. parallel to the envelope front side 102. Preferably, the means 112 are configured as a controlled or as a continually blowing nozzle so as to direct the fluid in the direction of the cover opening.

It shall be noted at this point that, in accordance with embodiments, a virtual envelope bottom 106′ is provided, for the fluid 116 flowing in, across the entire width of the envelope 100. However, the present invention is not limited to such an implementation; rather, it may be sufficient to act upon the envelope only at discrete points along its width so as to produce a plurality of portions at which the blow air 116 flowing in is at least partly reflected in the direction of the exit opening 118 without the envelope bottom 100 being reached. In addition, studies have shown that it may be sufficient to act upon an envelope only at one position along its width so as to provide, at this location, a reversal position for the fluid 116 flowing in. It was found, for example, that with certain envelopes, one such singular location is sufficient to result in a marked acceleration of the opening process.

Embodiments of implementing the means for providing the deflection position 120 will be explained in more detail below.

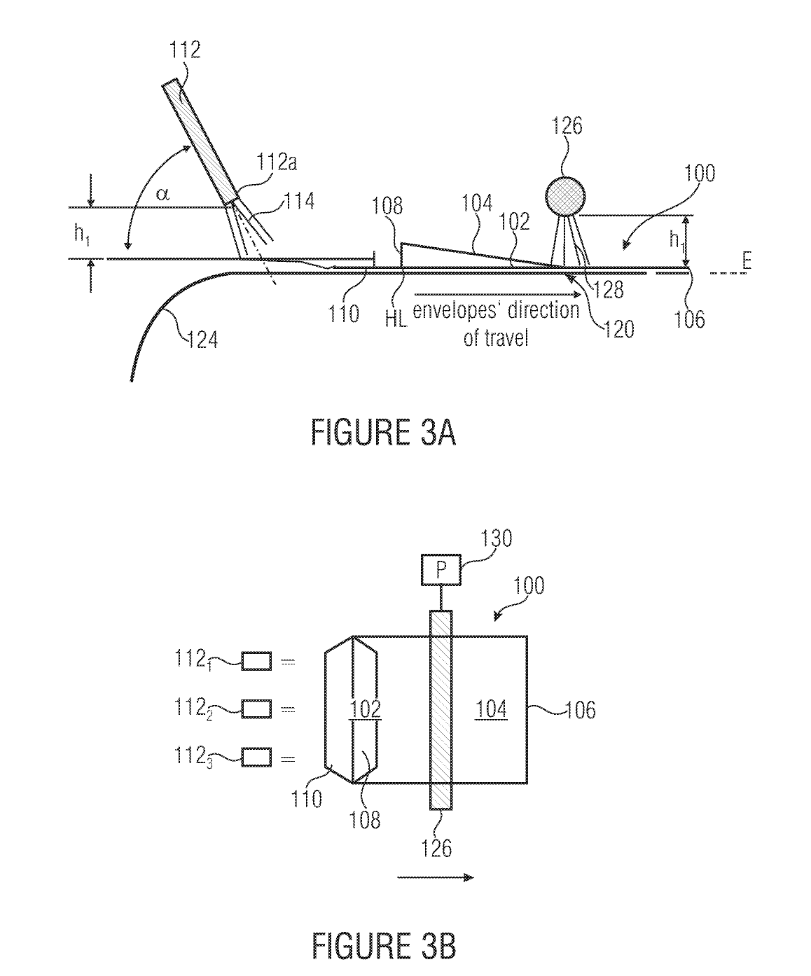

FIG. 3 shows an embodiment wherein a blow air strip is used, FIG. 3(A) showing a schematic lateral representation of the inventive device in accordance with this embodiment. FIG. 3(B) shows a top view, and FIGS. 3(C) to (F) show various implementations of the blow air strip.

FIG. 3 schematically shows an envelope feeder 124, along which the envelope 100 is fed in the envelopes' direction of travel. The blow air nozzle 112 is disposed above the plane E within which the envelope is moved so as to direct the blow air 114 in the direction of the envelope 100 from above and at an angle. The blow air nozzle 112 is arranged such that its exit opening 112a is at a distance h₁ from the plane E. The nozzle 112 is arranged at an angle a in relation to the plane E. The device includes a blow air strip 126 extending across the width of the envelope 100 and directing blow air 128 to the envelope 100 so as to bring about the deflection position 120 at a desired position at a distance from the hinge line HL. Thus, the blow air strip 126 creates the above-mentioned, smaller envelope height, so that the flow air introduced by the nozzle 112 is reflected at an earlier point in time, and so that faster and improved opening of the envelope occurs. In accordance with embodiments, the blow air strip is formed by a pipe mounted in a direction transverse to the envelopes' direction of travel and comprising a plurality of evenly distributed bores, the pipe being pressurized so as to achieve an action upon the envelope 100 for providing the deflection position 120. The blow air strip 126 can be activated/deactivated via a controller (not depicted), for example in dependence on a position which the envelope 100 has reached along an envelopes' direction of travel.

FIG. 3(B) shows a top view of the representation shown in FIG. 3(A). The blow air nozzle includes three individual nozzles 112₁ to 112₃, which direct blow air in the direction of the opening 108 of the envelope 100. The blow air strip 126 extends across the width of the envelope 100 in a direction transverse to the envelopes' direction of travel indicated by the arrow in FIG. 3(B). The blow air strip is connected to a blow air source 130, the blow air source 130 being able to supply the nozzles 112₁ to 112₃ with blow air simultaneously.

FIGS. 3(C) to (F) show various implementations of the underside (located opposite the envelope) of the blow air nozzle 126 shown in FIG. 3(B) so as to enable the blow air to exit. The implementation shown in FIG. 3(C) includes a plurality of openings arranged adjacently to one another, via which blow air provided by the source 130 may be directed to the envelope body at predetermined points. FIG. 3(B) shows an implementation wherein a plurality of slots arranged adjacently to one another are provided so as to enable the blow air to exit. As is shown in FIG. 3(E), a continuous slot may also be provided. As was already explained above, one single opening may also be sufficient, as is shown in FIG. 3(F), so as to provide a reflection point for the inbound blow air at only one position across the width of the envelope 100. In accordance with embodiments, the openings may be provided with valves which may be controlled individually, in groups or all together so as to control application of the blow air and, thus, creation of the deflection position.

FIG. 3 shows a first embodiment of non-contacting creation of the deflection position while using blow air. It shall be noted at this point that the invention is not limited to the utilization of air as the blow medium or blow fluid; rather, it is also possible to use other fluids, for example gases other than air. Moreover, the present invention is not limited to the utilization of blow air for creating the deflection position; for example, an electrostatic field may be generated by suitable electrodes, which results in the creation of one or more deflection positions across the width of the envelope 100.

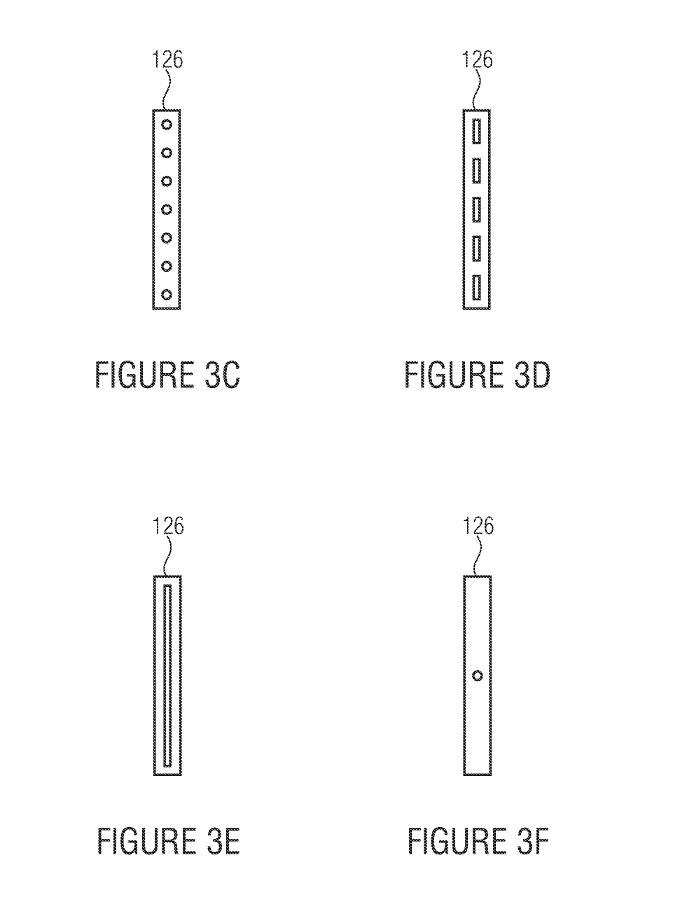

In addition, provision may be made for introducing a localized fold at one or more positions or across the entire width of the envelope, which will be explained in more detail below with reference to FIG. 4. FIG. 4(A) shows a lateral representation of a device in accordance with a further embodiment wherein the envelope 100 is arranged on a support plate 132, the support plate including a recess 134 extending from an upper surface of the support plate 132 to a lower surface thereof. A vacuum chamber 136 is located below the recess 134 and is effectively connected to a pump P so as to apply to the recess 134 sufficiently large amount of negative pressure to induce a fold 138 of the envelope, whereby one or more deflection positions are created which enable the above-described reflection of at least some of the inbound blow air before it reaches the real envelope bottom 106.

FIG. 4(B) shows a possible implementation of the support plate 132, which in the embodiment shown comprises six recesses 134₁ to 134₆ so as to induce the local folds 138 at six predetermined positions along the width of the envelope 100 and so as to thereby create a multitude of reflection positions 120. Depending on the circumstances, for example on the size of the envelope and on the property of the material of the envelope, provision may also be made for providing only some of the openings 134₁ to 134₆, possibly even only one central opening. In accordance with embodiments, the openings 134₁ to 134₆ may be provided with valves which may be controlled in order to control the application of vacuum force by same.

FIG. 4(C) shows an alternative implementation wherein the recess 134 is configured as a slot across the width of the plate 132 so as to generate a negative pressure and a fold 138 across the entire width of the envelope. Instead of the suction process, it is also possible to apply a pressure (e.g. by means of a stamp) to the upper surface of the envelope at a position opposite the opening to induce the fold. Alternatively, the envelope may be lifted at its envelope bottom so as to induce the fold.

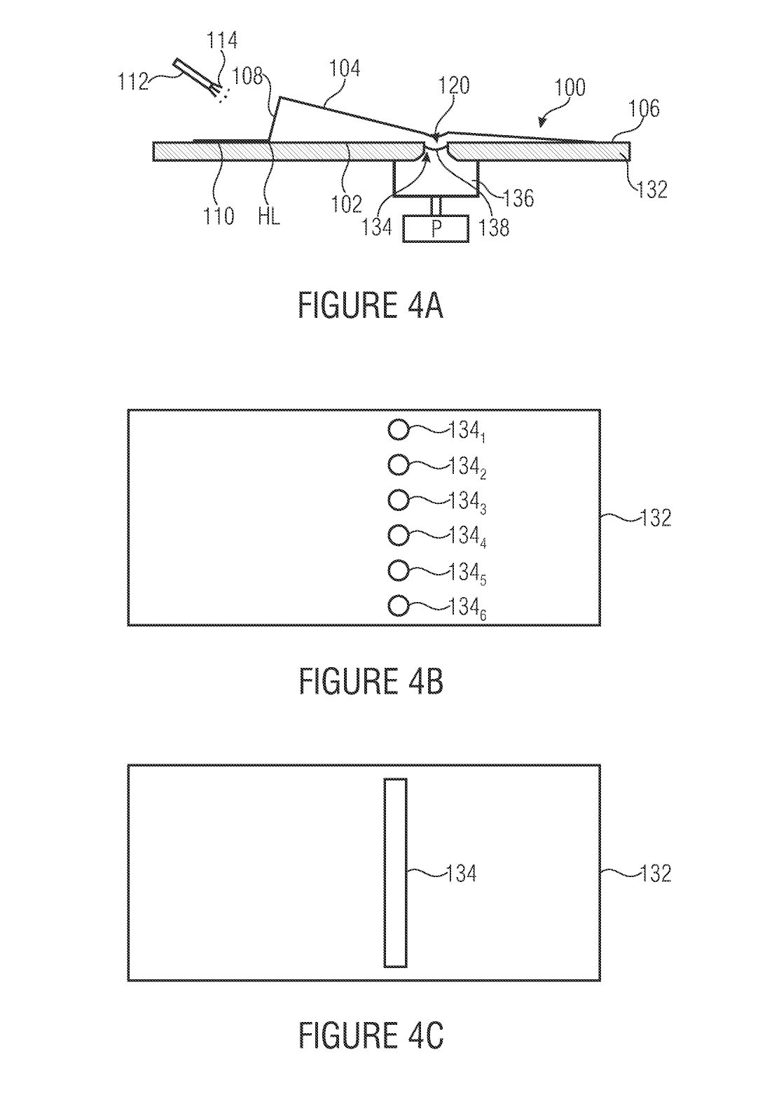

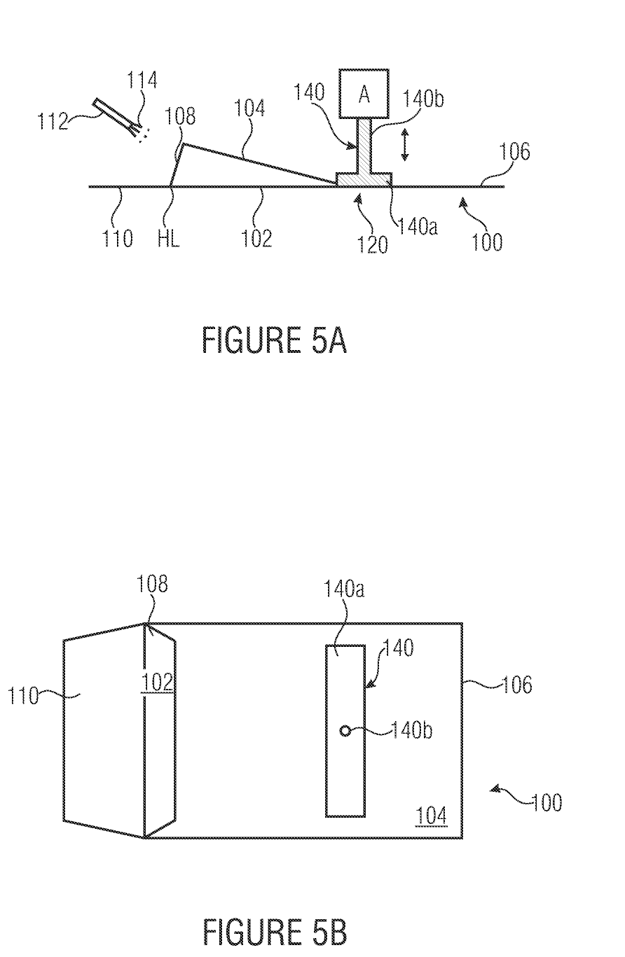

By means of FIGS. 3 and 4, embodiments are described wherein the deflection positions were created in an essentially non-contacting manner; however, the present invention is not limited to such implementations, as will be explained below in more detail with reference to FIGS. 5 and 6.

FIG. 5 shows a first embodiment of creating the deflection position in a contacting manner. FIG. 5(A) shows a lateral top-view representation of the envelope 100, similar to FIG. 3; however, instead of the blow air strip, a vertically movable stamp element 140 is provided which may be moved, while using the actuator A, between a position which is spaced apart from the envelope 100 and is located above the envelope 100 and the position shown in FIG. 5(A), wherein a stamp portion 140a of the stamp 140 is in contact with the envelope 100 and applies a pressure to the envelope 100. The stamp portion 140a is connected to the actuator A via a bar portion 140b. The stamp element 140 enables creation of a deflection position for inducing the above-described mode of action, namely an early reflection of at least some of the blow air flowing in.

FIG. 5(B) shows a first implementation of the stamp 140. In accordance with said embodiment, the stamp 140 includes a stamp portion 140a extending across a portion of the width of the envelope 100; it shall be noted at this point that the portion 140a may also extend beyond the width of the envelope 100. As is shown in FIG. 5(C), the stamp element may also be realized, alternatively, by a plurality of stamps 140₁ to 140₃, which may be controlled together or individually so as to provide discrete deflection positions at different locations along the width of the envelope 100; it is also possible to use only selected ones of the stamps 140₁ to 140₃, for example only one or two stamps, for creating a deflection position, depending on the properties of the envelope.

In addition, it shall be noted that the present invention is not limited to creating the deflection position in a linear manner along the width of the envelope 100; rather, it is also possible to create one or more positions 120 in a non-contacting or contacting manner via a bent portion, for example by means of a suitably bent stamp element 140, as is shown in FIG. 5(D).

However, the present invention is not limited to using a stamp element as was described by means of FIG. 5. Rather, other suitable elements may also be provided so as to act upon the envelope for creating the deflection position at one or more locations along its width. By means of FIG. 6, further examples of such elements are described, FIG. 6(A) depicting a spring-mounted roller 142 which is biased in the direction of the envelope 100 by means of the spring 144 and creates the deflection position 120. Likewise, a vertically movable roller 146 as is shown in FIG. 6(B) may be used. In a manner similar to the stamp element, it is also possible to provide several elements 142, 146 arranged one behind the other, it also being possible to provide, instead of the rollers mentioned, one axle in each case which extends in a direction transverse to the transport direction of the envelope. Alternatively, spring-biased elements may also act upon the envelope, it further being possible to provide simple drag belts instead of the active elements, which drag belts act upon part of the envelope. Likewise, fixed metal sheets may be arranged, beneath which the envelope is passed along, so that when it passes the position where the metal sheet is arranged, a corresponding deflection position is provided for the fluid streaming in for opening the envelope.

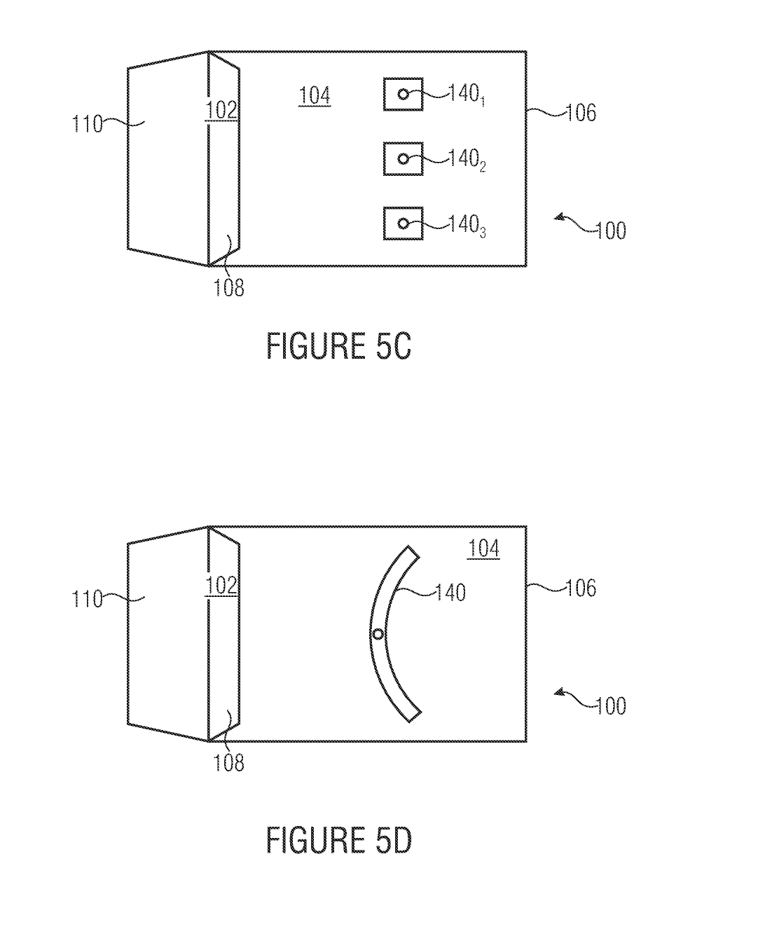

As was mentioned above, the inventive device is advantageously used in envelope inserters; by means of FIG. 7, an envelope inserter 150 is schematically shown which receives, at an input provided on the left of FIG. 7, an envelope and an item to be inserted. At the input, the envelope inserter 150 includes the inventive device in the form of the blow air nozzles 112₁ and 112₂ as well as in the form of the stamp elements 140₁ and 140₂, which act upon the envelope 100 so as to create the deflection positions 120₁ and 120₂, at which at least some of the fluid introduced by the blow air nozzles 112₁ and 112₂ is reflected prior to reaching the envelope bottom 106, which thus enables faster and more reliable opening of the envelope. Following the process of opening the envelope in the above-described manner, the envelope inserter 150 continues in a suitable manner to introduce the item into the envelope, so that finally, a filled envelope is removed from the envelope inserter 150. It shall be noted at this point that, by means of FIG. 7, an example of the inventive device was mentioned; however, one of the embodiments described above may be employed.

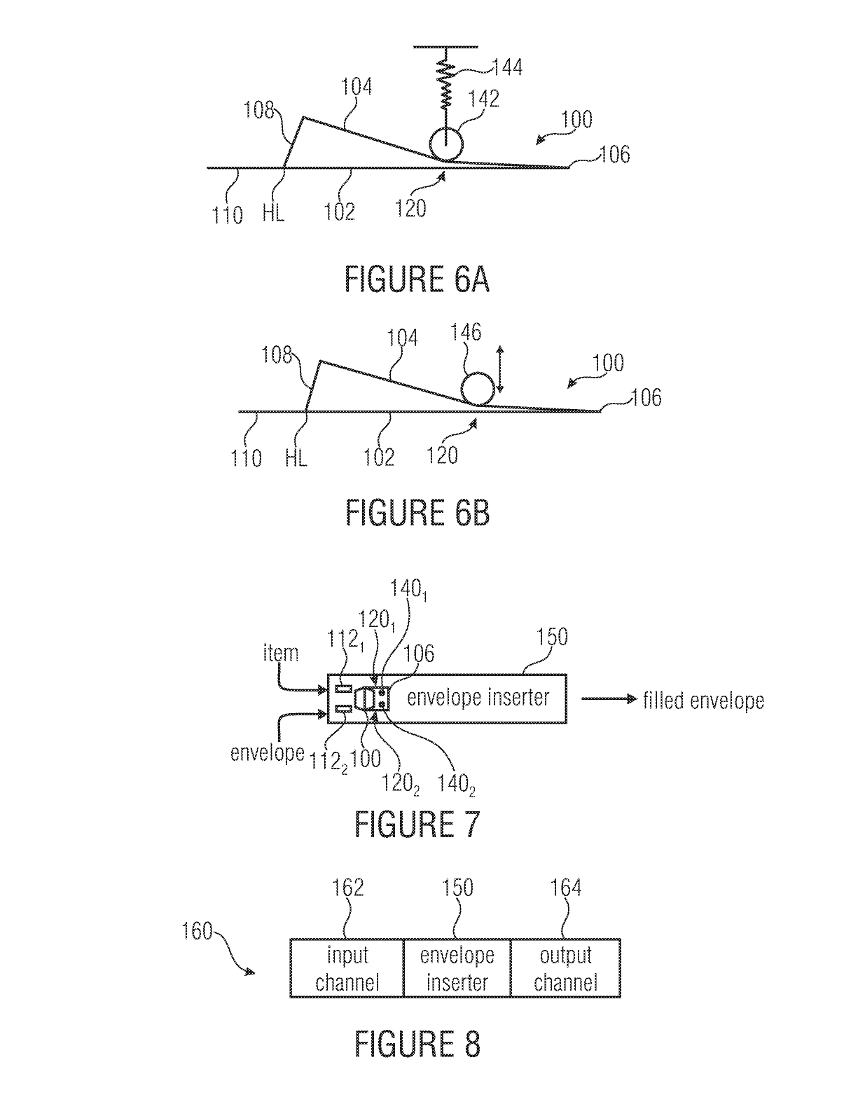

The envelope inserter as was described in FIG. 7 is advantageously employed in a paper-handling plant 160 schematically shown in FIG. 8. The paper-handling plant 160 includes an input channel 162 for receiving and preparing the goods to be inserted, which are introduced into corresponding envelopes within the envelope inserter, the envelope inserter 150 providing the inserted goods to an output channel 164 where post-processing of the envelope takes place. The input channel 162 may comprise a cutter, a merger, a collating station, a folding unit and/or an insert feeder, and the output channel 164 may include closing means for the filled envelope, a franking station and/or a storage tray.

In further embodiments, an element for inducing the deflection position may be provided which comes into contact with the cover body essentially without any pressurization. For example, a pair of rollers may be provided whose distance essentially corresponds to the thickness of the envelope, so that the envelope may be moved between the rollers without any pressurization. When the blow air is introduced into the envelope, the distance of the opposite sides will change, so that the envelope will abut against the rollers at the position of the rollers, which results in the deflection position. After the blowing-in process, the rollers may be moved apart from each other so as to prevent the opposite sides from coming into contact again.

In accordance with yet further embodiments, the deflection position may be created in that the envelope is subjected to an impulse/a pulse at the desired position. For example, an acoustic impulse/pulse may be provided. A sound source or an ultrasound source may be provided which directs the sound or ultrasound to the desired position of the envelope so as to cause the deflection position.

In accordance with embodiments of the invention, an approach is thus provided wherein a deflection position (position where at least some of the fluid which moves in the direction of the cover bottom is reflected back in the direction of the cover opening) is provided, for the fluid used for opening, in a direction transverse to the transport direction of the envelope or the cover. This may be effected by one of the above-described means which are arranged transversely, e.g. perpendicularly, to the transport direction and extend fully or partly across the width of the cover so as to act upon the cover in a non-contacting or contacting manner at one or more positions. The transport direction of the envelope or the cover designates, e.g., a direction along which the envelope or the cover is moved to a position where the envelope/cover is opened (also referred to as the feeding direction) and/or a direction along which the envelope or cover is moved away from the position where the envelope/cover is opened (also referred to as the removal direction). The envelope or cover may be filled with the item at that position at which the envelope/cover is opened. Alternatively, the item may also be filled in at a subsequent position.

Even though some aspects have been described within the context of a device, it is understood that said aspects also represent a description of the corresponding method, so that a block or a structural component of a device is also to be understood as a corresponding method step or as a feature of a method step. By analogy therewith, aspects that have been described in connection with or as a method step also represent a description of a corresponding block or detail or feature of a corresponding device.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. A device for opening a cover while using a fluid, comprising
an opener for at least partly separating a cover front side and a cover rear side of the cover,
the opener being configured to provide, for the fluid introduced into the cover, a deflection position between a cover opening and a cover bottom.

2. The device as claimed in claim 1, wherein the deflection position causes at least some of the fluid moving in the direction of the cover bottom to be reflected back in the direction of the cover opening.

3. The device as claimed in claim 1, wherein the opener is configured to release a fluid flow.

4. The device as claimed in claim 1, comprising a provider for providing the deflection position.

5. The device as claimed in claim 4, wherein the provider for providing the deflection position is configured to provide the deflection position in a non-contacting or contacting manner.

6. The device as claimed in claim 4, wherein the provider for providing the deflection position is configured to provide the deflection position across the width of the cover or at one or more predetermined locations along the width of the cover.

7. The device as claimed in claim 4, wherein the provider for providing the deflection position in a non-contacting manner comprises a strip configured to direct a fluid to the cover body at a predetermined pressure across the width of the cover or at one or more predetermined positions along the width of the cover, a generator for generating electrostatic forces across the width of the cover or at predetermined positions along the width of the cover, or an element which causes a fold in the cover at the deflection position.

8. The device as claimed in claim 4, wherein the provider for providing the deflection position in a contacting manner comprises an element configured to be brought into contact with the cover body across the width of the cover or at one or more predetermined positions along the width of the cover.

9. The device as claimed in claim 8, wherein the element is configured to apply pressure to the cover body.

10. The device as claimed in claim 8, wherein the element comprises one or more rollers arranged adjacently to one another, a shaft, one or more spring elements arranged adjacently to one another, or a clamp that can be brought into contact with the cover body.

11. The device as claimed in claim 1, wherein the fluid comprises a gas, e.g. blow air.

12. The device as claimed in claim 1, wherein the cover comprises an envelope comprising an envelope flap.

13. The device as claimed in claim 12, wherein the deflection position is arranged, independently of the envelope format, at a predetermined distance from the hinge line of the envelope.

14. The device as claimed in claim 1, wherein the deflection position is provided in a direction transverse to the transport direction of the cover.

15. An envelope inserter for inserting one or more goods into a cover, comprising a device for opening a cover while using a fluid, the device comprising:
an opener for at least partly separating a cover front side and a cover rear side of the cover,
the opener being configured to provide, for the fluid introduced into the cover, a deflection position between a cover opening and a cover bottom.

16. A paper-handling plant comprising a device as claimed in claim 1 and/or an envelope inserter for inserting one or more goods into a cover, comprising a device as claimed in claim 1.

17. A method of opening a cover while using a fluid, a deflection position being provided, for the fluid introduced into the cover, between a cover opening and a cover bottom.

18. The method as claimed in claim 17, comprising:
introducing the fluid into the cover.

19. The method as claimed in claim 17, comprising:
partially deflecting the fluid at the deflection position within the cover, the deflection position not being the cover bottom.

20. The method as claimed in claim 17, wherein at least some of the fluid moving in the direction of the cover bottom is reflected back into the direction of the cover opening at the deflection position.

21. The method as claimed in claim 17, wherein the deflection position is provided in a direction transverse to the transport direction of the cover.
